(19) United States
(12) Patent Application Publication
(10) Pub. No.: US 2026/0206700 A1
(43) Pub. Date: Jul. 23, 2026

(54) ALGAE HARVESTING DEVICE

(71) Applicant: UNIVERSITY OF TECHNOLOGY SYDNEY, Ultimo, New South Wales (AU)

(72) Inventors: Qiang FU, Ultimo, New South Wales (AU); Luong NGUYEN, Ultimo, New South Wales (AU); Peter RALPH, Ultimo, New South Wales (AU); Long D NGHIEM, Ultimo, New South Wales (AU)

(21) Appl. No.: 19/139,901

(22) PCT Filed: Dec. 19, 2023
(86) PCT No.: PCT/AU2023/051328

§ 371 Date: Jun. 17, 2025

(30) Foreign Application Priority Data
Dec. 19, 2022 (AU) 2022903897

(51) Int. Cl. A01G 33/00; B01D 33/11; B01D 33/50

(52) U.S. Cl. CPC A01G 33/00; B01D 33/11; B01D 33/50; B01D 2257/91

(57) ABSTRACT

Disclosed herein is an algae harvesting device. The device may comprise; a rotatable filtration unit having an outer wall defining an internal chamber therein; an inlet for introducing a fluid containing algae into the internal chamber; a container within which the rotatable filtration unit rotates; an algae collector disposed within the internal chamber configured to collect algae; and an outlet for discharging algae.

The present application claims priority to Australian provisional Patent Application No. 2022903897 filed 19 Dec. 2022, the entire disclosure of which is incorporated herein by cross-reference.

### TECHNICAL FIELD

The present disclosure relates to an algae harvesting device for harvesting algae from a fluid.

### BACKGROUND ART

Microalgae is an excellent platform for capturing carbon dioxide and producing biochemicals. Once cultivated, microalgae cells may be separated from the cultivation solution for further processing, including water recycling. Microalgae cells are small (~50 μm) and negatively charged so that they can remain in solution as individual cells without aggregation.

Current techniques to separate (harvest) microalgae cells from mature cultivation include centrifugation and membrane separation. Centrifugation and membrane separation techniques work against the nature of individual microalgae cells and use physical force to remove water and to form microalgae aggregation. Thus, equipment that utilises such techniques is expensive, and consumes considerable energy during operation.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

The Applicant has designed a mechanical device able to be used to harvest microalgae cells from solution on a continuous basis at relatively low equipment and running cost. Depending upon the application, the microalgae to be harvested may be either “pre-aggregated” by polymer flocculation or harvested without pre-treatment (e.g. harvesting of spirulina microalgae for use in high-value applications). The device can be used at algae farms for daily harvesting. It can also be used in emergency response to algae bloom management. The apparatus may also be useful for conventional water and wastewater treatment.

Further, the algae harvesting device is designed to work with both microalgae (i.e. micro size), cyanobacteria (blue-green algae) and filamentous algae (macro size). In the application for microalgae, the device may work in tandem with an in-situ polymer to flocculate algae into a larger size, facilitating a simple separation process. For cyanobacteria and filamentous algae, the device may be used directly with up to ~100% harvesting efficiency at minimal energy input.

Disclosed herein is an algae harvesting device. The device may comprise; a rotatable filtration unit extending along a longitudinal axis and comprising an outer wall defining an internal chamber therein; an inlet for introducing a fluid containing algae into the internal chamber of the rotatable filtration unit; a container within which the rotatable filtration unit rotates; an algae collector disposed within the internal chamber of the rotatable filtration unit and configured to collect algae as the rotatable filtration unit rotates within the container; and an outlet for discharging algae collected by the algae collector from the internal chamber of the rotatable filtration unit.

In some forms, the outer wall of the rotatable filtration unit is mesh. In some forms, the mesh outer wall of the rotatable filtration unit is configured to inhibit algae from passing through the mesh while allowing water contained in the fluid introduced into the internal chamber of the rotatable filtration unit to pass through the mesh and into the container.

In some forms, the mesh outer wall comprises four mesh panels that are mounted together to form a cylindrical mesh outer wall of the rotatable filtration unit. This provides a robust and economical method of manufacturing the drum.

In some forms, the algae collector is mounted within the rotatable filtration unit such that it remains in a fixed position as the rotatable filtration unit rotates about the algae collector.

In some forms, the algae collector is mounted to a wall of the container. This enables the algae collector to remain in a fixed position while the rotatable filtration unit rotates about the algae collector. The mounting may be in the form of a slot formed through a wall of the container (i.e. the collector is cantilevered from the slot). Advantageously, this allows for the collector to be easily inserted and removed from the algae harvesting device.

In some forms, the rotatable filtration unit is at least partially open at a first end of the rotatable filtration unit, and wherein a mounting structure configured to mount the algae collector to the wall of the container extends through the opening of the first end of the rotatable filtration unit. This mounting structure may form part of the collector itself.

In some forms, the algae collector is a trough comprising a first side, a second side and a middle portion disposed between the first and second side. In some forms, the first side extends along a first axis that is substantially perpendicular to the longitudinal axis of the rotatable filtration unit, the second side extends along a second axis that is substantially perpendicular to the longitudinal axis of the rotatable filtration unit, the first and second axes forming an obtuse angle therebetween.

In some forms, the middle potion of the trough is curved in profile to form a channel for the collected algae.

In some forms, the trough extends along a third axis, the third axis forming an acute angle with the longitudinal axis of the rotatable filtration unit such that algae moves along the channel and into the outlet.

In some forms, the trough has a parabolic type profile.

In some forms, the device comprises a fluid injector disposed outside the rotatable filtration unit, the fluid injector being configured to discharge a fluid at the rotatable filtration unit as it rotates to dislodge algae disposed along an inner surface of the outer wall of the rotatable filtration unit. The fluid injector is particularly advantageous for algae that adheres to the surface of the rotatable filtration unit and is not simply dislodged by gravity.

In some forms, the fluid injector comprises a set of nozzles directed towards the outer wall of the rotatable filtration unit.

In some forms, the nozzles of the fluid injector are disposed along a conduit that extends through opposing outer ends of the container.

In some forms, the conduit of the fluid injector extends along an axis that is disposed parallel with the longitudinal axis of the rotatable filtration unit.

In some forms, the fluid injector is disposed above the rotatable filtration unit in use.

In some forms, a second end of the rotatable filtration unit comprises a rotatable wall that extends perpendicular to the longitudinal axis of the rotatable filtration unit.

In some forms, the rotatable wall comprises gear teeth about the circumference of the rotatable wall.

In some forms, the device includes a motor for rotating the rotatable filtration unit.

In some forms, the device includes a shaft extending from the motor, the shaft comprising gear spaced from the motor and configured to mesh with the gear teeth of the rotatable wall of the rotatable filtration unit and thereby rotate the rotatable filtration unit.

### BRIEF DESCRIPTION OF DRAWINGS

Various embodiments/aspects of the disclosure will now be described with reference to the following figures.

FIG. 1 shows a schematic of the algae harvesting device according to the present disclosure;

FIG. 2 shows a cross-sectional view through the algae harvesting device of FIG. 1;

FIG. 3 shows a side perspective view of a panel of the outer wall of the drum of the algae harvesting device of FIG. 1;

FIG. 4 shows a perspective top view of the algae harvesting device of FIG. 1;

FIG. 5 shows a front view of the front wall of the drum of the algae harvesting device of FIG. 1;

FIG. 6 shows a top view of the trough of the algae harvesting device of FIG. 1; and

FIG. 7 shows a front view of the drum and the gear (drive) mechanism of the algae harvesting device of FIG. 1.

### DETAILED DESCRIPTION

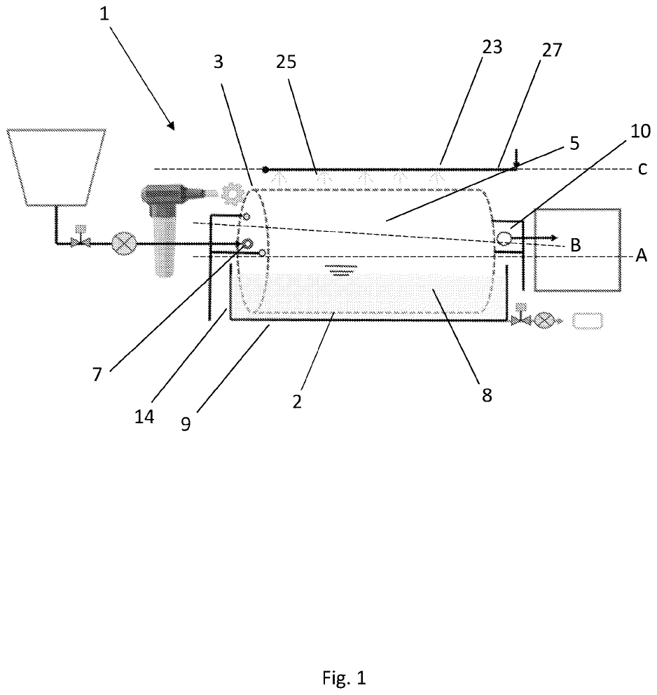

Disclosed herein is an algae harvesting device. The algae harvesting device will now be described with reference to FIGS. 1 to 7.

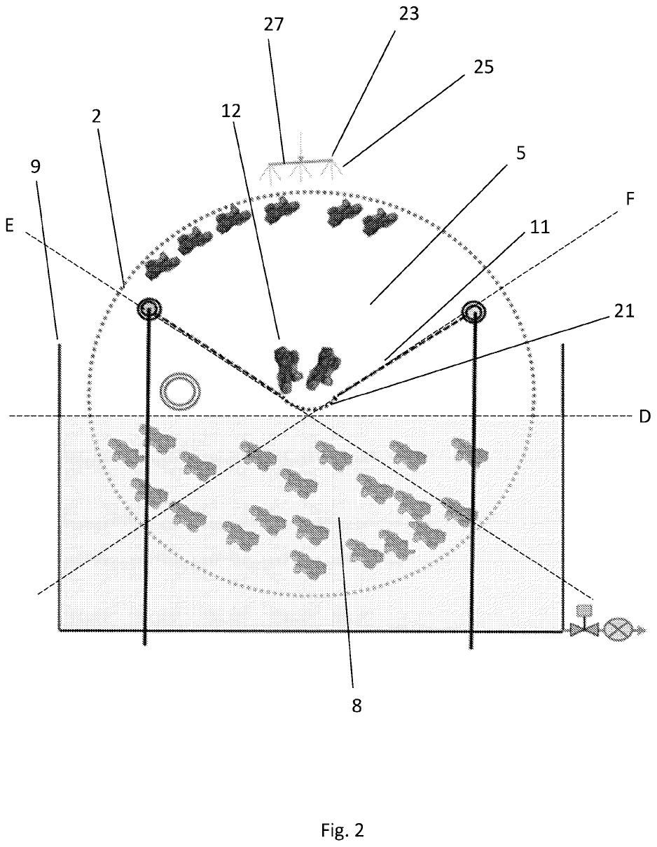

FIG. 1 shows a schematic of the algae harvesting device 1. The algae harvesting device includes a rotatable filtration unit, in the form of a drum 3, extending along a longitudinal axis A of the drum 3. The drum 3 includes an outer wall 2 defining an internal chamber 5 (see also FIG. 2). The algae harvesting device 1 includes an inlet 7 for introducing a fluid containing algae, in the form of algae solution 8, into the chamber 5. The drum 3 is housed in a container, in the form of a tank 9, within which the drum 3 rotates.

The algae harvesting device 1 will now be described in further detail with reference to FIG. 2, which shows a cross-sectional view through the algae harvesting device 1. Disposed within the chamber 5 of the drum 3 is an algae collector, in the form of a trough 11. Trough 11 is configured to collect algae 12 as the drum 3 rotates. The algae harvesting device 1 also includes an outlet 10 (see FIG. 1) for discharging algae 12 collected by the trough 11.

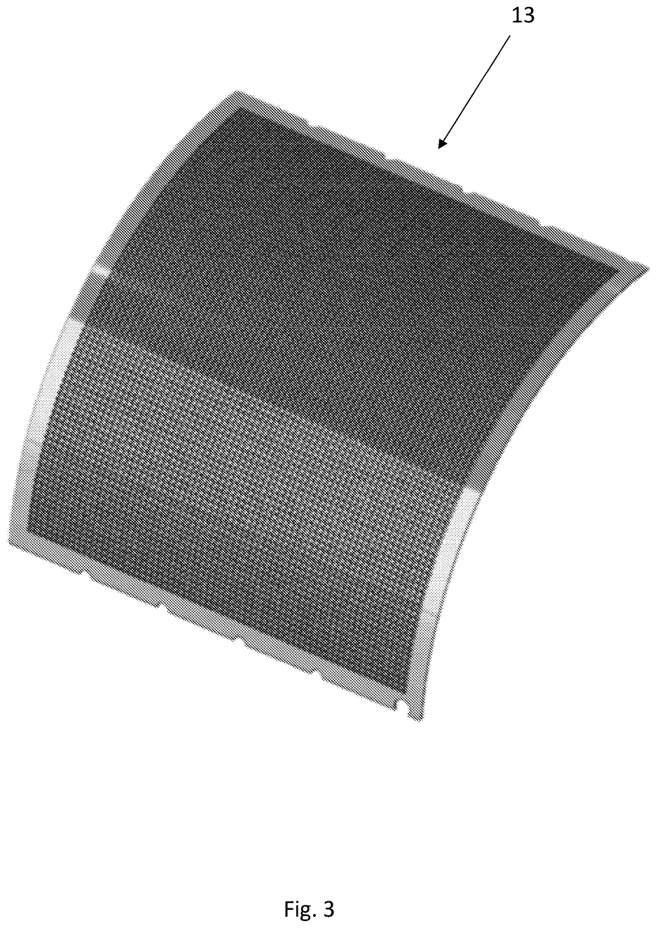

FIG. 3 shows a single panel 13 of the outer wall 2 of drum 3. The panel 13 includes a mesh configuration that forms the outer wall 2 of the drum 3. In the detailed embodiment, the outer wall 2 includes four mesh panels 13 that are mounted together to form the cylindrical outer wall 2 of the drum 3 (see FIGS. 1 and 2). The mesh is configured to inhibit algae from passing through the mesh while allowing water contained in the algae solution 8 introduced into the internal chamber 5 of the drum 3 to pass through the mesh and into the tank (see FIG. 2). In the detailed embodiment, the size of the mesh is within a range of 40 to 100 μm to correspond with the target algae cell or aggregate size. As will be evident to the skilled addressee, the appropriate mesh size can be selected to correspond with the diameter of a target algae (or flocculated algae).

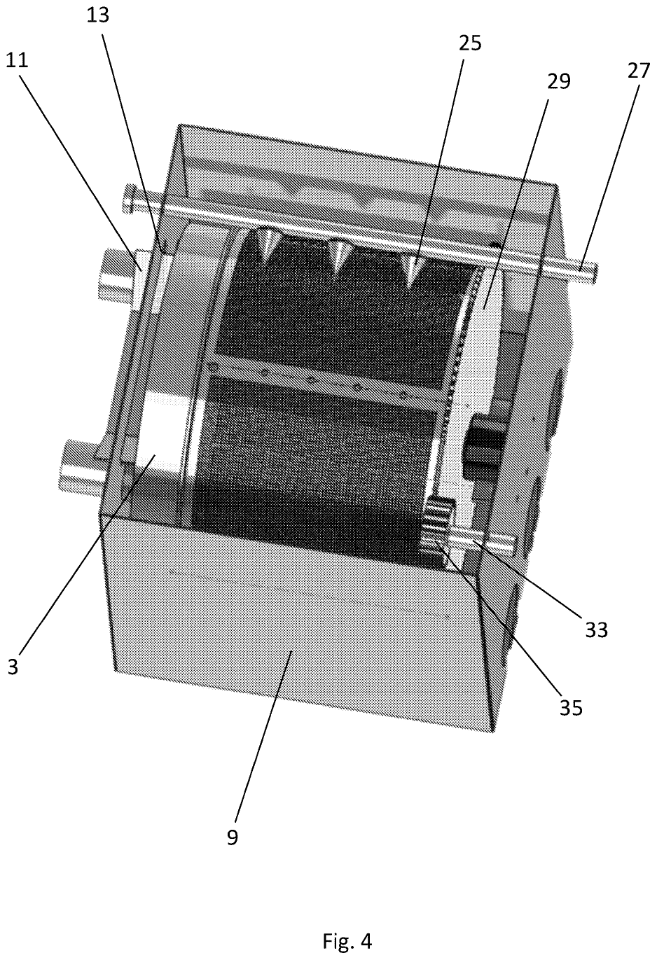

FIG. 4 provides a perspective top view of the algae harvesting device 1. The trough 11 is mounted to the front wall 14 of the tank via an open slot 13 within the front wall, which allows the trough 11 to be secured to the tank by being placed within the slot (i.e. it is cantilevered from the slot 13). This allows the trough 11 to float freely within the chamber 5 and unconnected to the drum 3, which in turn allows the trough 11 to remain in a fixed position within, and with respect to, the chamber 5 as the drum 3 rotates around it. As will be evident to the skilled addressee, other mounting arrangements between the trough 11 and tank 9 could be implemented to maintain the position of the trough 11 as the drum 3 rotates about the trough 11.

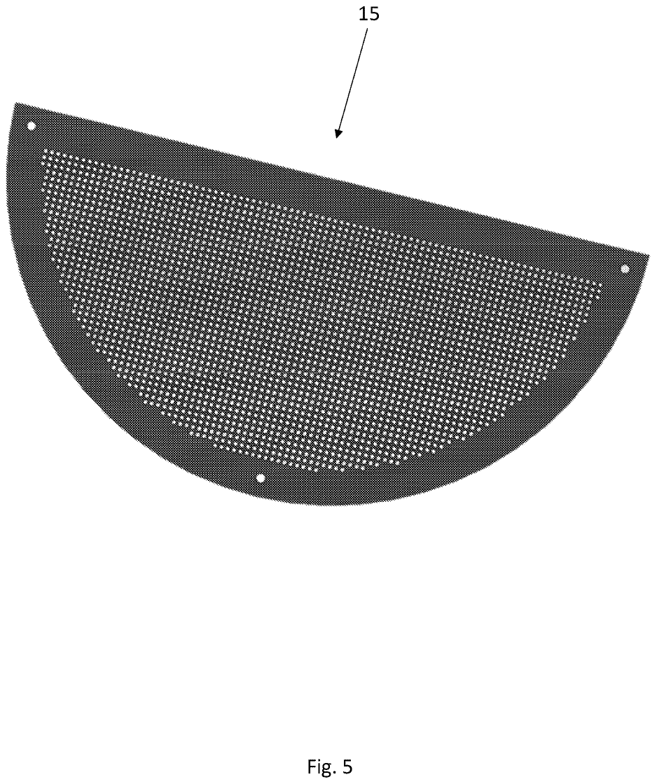

FIG. 5 provides a front view of the front wall of the drum 3. The drum 3 is partially open at the front end (in the detailed embodiment, this is the end connected to the inlet 7), and a semi-circular mesh panel 15 is secured to the bottom half of the front end, leaving the top half open. In detail, the non-curved edge of the semi-circular mesh panel 15 extends along axis D (FIG. 2), and the curved edge of the semi-circular mesh panel 15 is secured to the circumference of the bottom half of outer wall 2 of the drum 3. This leaves the space above the mesh panel 15 within the circumference of the outer wall 2 open to enable the tough 11 to be mounted to the tank 9.

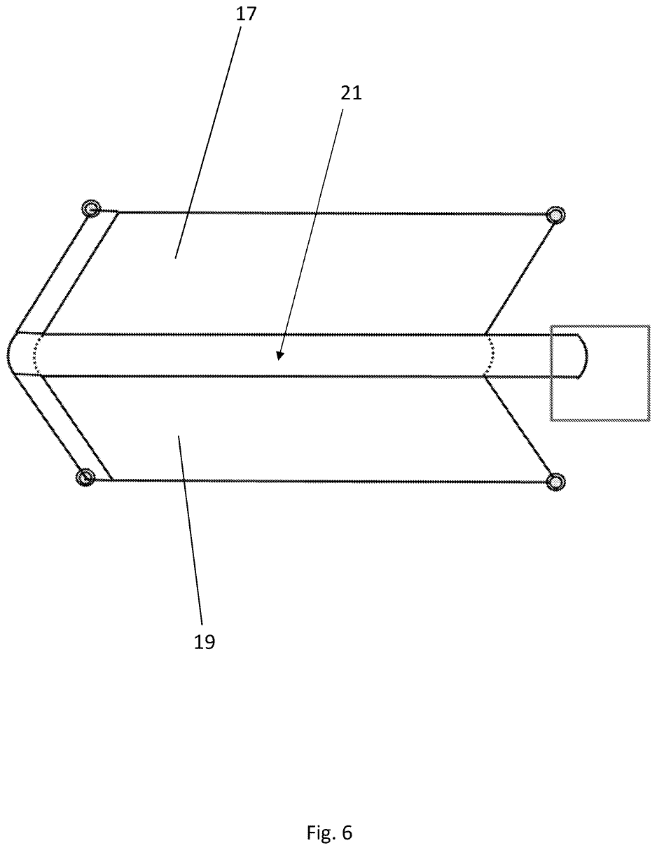

The trough 11 will now be described in further detail with reference to FIG. 6, which provides a top view of the trough 11. The trough 11 includes a first side 17, second side 19 and a middle portion 21. In the detailed embodiment, the middle portion 21 exhibits a curved profile to form a channel for the collected algae. The trough 11 extends along a third axis B that forms an acute angle with the longitudinal axis A of the drum 3 such that algae 12 moves along the channel and into the outlet 10 (i.e. the angle generates fall along the length of the trough 11). In the detailed embodiment, the angle of the trough relative to the longitudinal axis A of the drum is around 30 degrees. As will be evident to the skilled addressee, an alternate angle may be implemented, and will be dependent on many factors, such as the species of algae and the profile of the trough. However, the Applicant has determined that an angle of around 30 degrees (e.g. in the range of 25 to 35 degrees) is sufficient to provide a flow of algae from the trough. In the detailed embodiment, the trough 11 has a parabolic type profile. The first side extends along an axis E (see FIG. 2) that is substantially perpendicular to the longitudinal axis of the rotatable filtration unit. The second side extends along an axis F (see FIG. 2) that is also substantially perpendicular to the longitudinal axis of the rotatable filtration unit. The first and second axes form an obtuse angle therebetween.

Returning now to FIGS. 1, 2 and 4, a fluid injector that may optionally form part of the algae harvesting device 1 will now be described. In the detailed embodiment, the algae harvesting device 1 includes a fluid injector 23 disposed outside the drum 3. The fluid injector 23 is configured to discharge a fluid at the drum 3 as it rotates to dislodge algae disposed along the inner surface of the outer wall 2 of the drum 3. The fluid injector 23 includes a set of nozzles 25 (three in the detailed embodiment) directed towards the outer wall 2 of the drum 3. The nozzles 25 are disposed along a conduit 27 that extends through opposing outer ends of the tank 9 along axis C that is substantially parallel with the longitudinal axis A of the drum 3 (see FIG. 1).

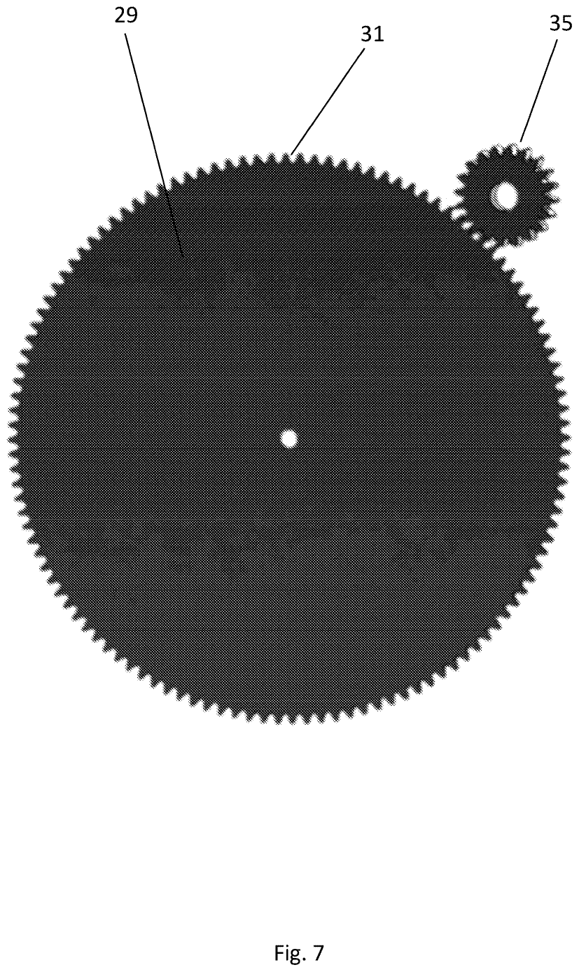

The drive mechanism that is operable to rotate the drum 3 will now be described with reference to FIG. 7, which provides a front view of the second end of the drum 3 and the corresponding gear (drive) mechanism. A second end of the drum 3 is substantially closed off by a rotatable wall 29 secured to the outer edge of said second end of the drum 3. The rotatable wall 29 is disposed perpendicular to the longitudinal axis A of the drum 3. The circumference of the rotatable wall 29 includes gear teeth 31. Included in the algae harvesting device 1 is a shaft 33 extending from a motor. The shaft includes a gear 35, spaced at the opposite end of said shaft from the motor, that is configured to mesh with the gear teeth 31 of the rotatable wall 29. In operation, the motor turns shaft 33 and its associated gear 35, thereby causing the rotatable wall 29, and thereby the drum 3 to which it is secured, to rotate. In the detailed embodiment, the motor is set to cause rotation of the drum 3 at a rate of around one cycle per minute. This rotation rate was selected to maximise the algae biomass deposition on the mesh. The rotation rate may be reduced when harvesting a pre-aggregated algae or filamentous algae.

Harvesting Efficiency with Arthospira Maxima in Food Supplement Production

Arthrospira Maxima is a photosynthetic, filamentous, spiral-shaped, multicellular cyanobacterium. Arthrospira Maxima is among the richest sources of proteins. Their biomass is presently marketed as a food supplement. In order to test the disclosed algae harvesting device, Arthrospira Maxima was cultivated a pilot scale 350 L photobioreactor. The photobioreactor had a diameter of 65 cm, total liquid height of 135 cm. It was sparged with air through airlines on either side of the bioreactor (1 mm needle). It was illuminated with 6 cool white LED strips running the height of the bag, equidistantly placed surrounding the bag. The fresh water for the large-scale bioreactor was first sterilized by addition of 0.2 mL of 12% sodium hypochlorite per L, followed by 0.2 mL of 2 M sodium thiosulphate per L. Culture media including 13.6 g/L sodium bicarbonate and 0.2 g/L of a commercially available fertiliser was added, and the algal bioreactor was maintained in a temperature controlled room of ~23° C. and given ~400 μmol photons/m²/s light in a 16:8 h light: dark cycle. The pH of algae solution was 8.5 on day 1 and it raised and stabled at 10.5 from day two onwards. The growth of the algae was monitored daily by measuring the OD at 680 nm in a spectrophotometer (Agilent Cary 60; Santa Clara, CA, USA). The photobioreactor was maintained for 14 days and the growth biomass was checked before harvesting. The optical density at 680 nm and dry weight of the Arthospira maxima solution before harvesting were 4.23 and 0.8 g/L, respectively.

Arthrospira Maxima solution was pumped directly into the algae harvesting device 1 via the inlet 7 at a flow rate of 60 L/min. The algae biomass was deposited on the stainless steel mesh of the drum 3 and clean water flowed out the algae harvesting device by gravity into a collection tank. The stainless steel mesh was fixed on the rotating drum 3 that turned at a speed of 1 cycle/min. The deposited algae biomass detached from the mesh and flowed into the collection trough 11. The optical density of clean water was measured and compared with the initial density of algae solution for evaluation of harvesting efficiency (Table 1). Clean water was returned for the next culture. The table below provides parameters of Arthospira Maxima solution before and after harvesting with the disclosed algae harvesting device.

| | Optical density | Dry weight | Harvesting |
|---|---|---|---|
| Arthospira Maxima | (680 nm) | (g/L) | efficiency (%) |
| Initial | 4.23 | 0.8 | |
| After harvesting | 0.016 | 100 | 99.6 |

Harvesting Efficiency with Freshwater Scenedesmus sp in Carbon Capture System

Scenedesmus is a genus of green algae, in the class Chlorophyceae. They are colonial and non-motile. Scenedesmus sp is a high growth rate algae, which can be used for direct air carbon capture. Dry biomass of Scenedesmus sp contains 13% lipid, 95 starch and 38% other carbohydrates. Thus, 1 kg of Scenedesmus sp contains 0.45 kg carbon or 1.65 kg of CO2.

Scenedesmus sp growth rate was measured via optical density at 680 nm. The optical density and dry weight of the Scenedesmus sp solution before harvesting were 1.3 and 0.2 g/L, respectively.

The initial Scenedesmus sp was flocculated with a polymer at an optimal dose of 1 mg polymer per L of algae solution. The resultant flocculated algae solution was pumped into the algae harvesting device 1. Harvesting efficiency and biomass concentration after harvesting are presented in the table below, which provides parameters of Scenedesmus sp solution before and after harvesting.

| | Optical density | Dry weight | Harvesting |
|---|---|---|---|
| Scenedesmus sp | (680 nm) | (g/L) | efficiency (%) |
| Initial | 1.3 | 0.2 | |
| After harvesting | 0.06 | 32 | 99 |

Harvesting Efficiency with Seawater Phaeodactylum tricornutum

The marine diatom P. tricornutum CCMP 632 was obtained from the National Center for Marine Algae and Microbiota (East Boothbay, ME, USA). It was kept in marine f/2 media using 0.22 μm filtered autoclaved seawater collected from Sydney Harbour (salinity of 33 to 35 g/L).

P. tricornutum was cultivated for 20 days. The optical density and dry weight of the P. tricornutum solution before harvesting were 0.23 and 0.01 g/L, respectively.

The initial P. tricornutum was flocculated with a polymer at an optimal dose of 3 mg polymer per L of algae solution. The resultant flocculated algae solution was pumped into the algae harvesting device 1. Harvesting efficiency and biomass concentration after harvesting are presented in the table below, which provides parameters of P. tricornutum solution before and after harvesting.

| | Optical density | Dry weight | Harvesting |
|---|---|---|---|
| P. tricornutum | (680 nm) | (g/L) | efficiency (%) |
| Initial | 0.23 | 0.01 | |
| After harvesting | 0.04 | 0.75 | 82 |

To summarise, broadly speaking the disclosed embodiment includes a rotating drum made of stainless steel mesh, algae solution inlet, clean water outlet, dense algae biomass outlet, algae collection trough, and optional cleaning spray pump or air pump. The system can be operated continuously. Algae solution is pumped to the centre of the rotating drum. Water is drained out by gravity and the algae biomass is retained. As the drum rotates, the retained biomass is moved upward. A spray pump or air pump may be optionally used to detach the algae biomass from the drum mesh, allowing it to fall by gravity to a collection trough at the middle of the drum. The mesh size of the rotating drum is adjustable in the range of 40 to 100 μm to match the target algae cell or aggregate sizes. The disclosed system can be used directly to remove or harvest multi-cell microalgae such as spirulina or applied in conjunction with a polymer flocculation. The polymer flocculation may combine million(s) of individual algae cells into flocs (i.e. size of 5 mm).

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. An algae harvesting device comprising;
a rotatable filtration unit extending along a longitudinal axis and comprising an outer wall defining an internal chamber therein;
an inlet for introducing a fluid containing algae into the internal chamber of the rotatable filtration unit;
a container within which the rotatable filtration unit rotates;
an algae collector disposed within the internal chamber of the rotatable filtration unit and configured to collect algae as the rotatable filtration unit rotates within the container; and
an outlet for discharging algae collected by the algae collector from the internal chamber of the rotatable filtration unit.

2. An algae harvesting device according to claim 1, wherein the outer wall of the rotatable filtration unit is mesh.

3. An algae harvesting device according to claim 2, wherein the mesh outer wall of the rotatable filtration unit is configured to inhibit algae from passing through the mesh while allowing water contained in the fluid introduced into the internal chamber of the rotatable filtration unit to pass through the mesh and into the container.

4. An algae harvesting device according to claim 2, wherein the mesh outer wall comprises four mesh panels that are mounted together to form a cylindrical mesh outer wall of the rotatable filtration unit.

5. An algae harvesting device according to claim 1, wherein the algae collector is mounted within the rotatable filtration unit such that it remains in a fixed position as the rotatable filtration unit rotates about the algae collector.

6. An algae harvesting device according to claim 5, wherein the algae collector is mounted to a wall of the container.

7. An algae harvesting device according to claim 6, wherein the rotatable filtration unit is at least partially open at a first end of the rotatable filtration unit, and wherein a mounting structure configured to mount the algae collector to the wall of the container extends through the opening of the first end of the rotatable filtration unit.

8. An algae harvesting device according to claim 5, wherein the algae collector is a trough comprising a first side, a second side and a middle portion disposed between the first and second side.

9. An algae harvesting device according to claim 8, wherein the first side extends along a first axis that is substantially perpendicular to the longitudinal axis of the rotatable filtration unit, the second side extends along a second axis that is substantially perpendicular to the longitudinal axis of the rotatable filtration unit, the first and second axes forming an obtuse angle therebetween.

10. An algae harvesting device according to claim 9, wherein the middle potion of the trough is curved in profile to form a channel for the collected algae.

11. An algae harvesting device according to claim 10, wherein the trough extends along a third axis, the third axis forming an acute angle with the longitudinal axis of the rotatable filtration unit such that algae moves along the channel and into the outlet.

12. An algae harvesting device according to claim 11, wherein the trough has a parabolic type profile.

13. An algae harvesting device according to claim 1, comprising a fluid injector disposed outside the rotatable filtration unit, the fluid injector being configured to discharge a fluid at the rotatable filtration unit as it rotates to dislodge algae disposed along an inner surface of the outer wall of the rotatable filtration unit.

14. An algae harvesting device according to claim 13, wherein the fluid injector comprises a set of nozzles directed towards the outer wall of the rotatable filtration unit.

15. An algae harvesting device according to claim 14, wherein the nozzles of the fluid injector are disposed along a conduit that extends through opposing outer ends of the container.

16. An algae harvesting device according to claim 15, wherein the conduit of the fluid injector extends along an axis that is disposed parallel with the longitudinal axis of the rotatable filtration unit.

17. An algae harvesting device according to claim 13, wherein the fluid injector is disposed above the rotatable filtration unit in use.

18. An algae harvesting device according to claim 1, wherein a second end of the rotatable filtration unit comprises a rotatable wall that extends perpendicular to the longitudinal axis of the rotatable filtration unit.

19. An algae harvesting device according to claim 18, wherein the rotatable wall comprises gear teeth about the circumference of the rotatable wall.

20. An algae harvesting device according to claim 19, comprising a motor for rotating the rotatable filtration unit, and further comprising a shaft extending from the motor, the shaft comprising gear swpaced form the motor and configured to mesh with the gear teeth of the rotatable wall of the rotatable filtration unit and thereby rotate the rotatable filtration unit.

21. (canceled)
